(19) United States
(12) Patent Application Publication
(10) Pub. No.: US 2002/0147776 A1
(43) Pub. Date: Oct. 10, 2002

(54) System and method for monitoring consumer preferences

(75) Inventors: Joshua Lippiner, New York, NY (US); Joseph Dodson, New York, NY (US); Eric Grunin, New York, NY (US)

Correspondence Address: BAKER & BOTTS, 30 ROCKEFELLER PLAZA, NEW YORK, NY, 10112

(73) Assignee: cPulse LLC

(21) Appl. No.: 09/826,802

(22) Filed: Apr. 5, 2001

(51) Int. Cl. G06F 15/16

(52) U.S. Cl. 709/204; 709/218; 709/227

(57) ABSTRACT

A system and method are provided for monitoring the preferences of web site visitors. The system and method can be computer-based and can be embodied as an application program or module connected to or incorporated into any communications network including: the Internet, an intranet, a local area network, and/or a wide area network. The system and method can voluntarily collect statistically relevant data regarding customers wants, needs and practices through a non-intrusive pop-up window.

### FIELD OF THE INVENTION

This present invention relates to a system for administering a survey or questionnaire to a sample of users of a computer network and, more particularly, a system for administering a survey for Internet web site visitors.

### BACKGROUND OF THE INVENTION

The popularity of personal computers has increased dramatically in the past decade. Each year an increasing number of people start using personal computers in increasingly diverse ways. This expansion of computer use has resulted in the formation of on-line market places, called web sites, which advertise products and services over communications networks such as the Internet. Web sites allow users to view content stored on computers linked to the communications network. Web sites not only have pictures and text, but may also have audio or video information available for the user. Many types of products and services are marketed, promoted and sometimes sold through these web sites. Products offered by web sites include everything from digital music and books to automobiles.

Each site on the Internet is a construction of many different “pages,” each written in a computer language that is interpreted by web browsers such as Netscape Navigator or Microsoft's Internet Explorer. Each page contains text information, formatting information, and link information for the page. The link information provides both references to the location of graphic images and references to other web pages. One of the most common image formats used on the web is known as graphics image format or GIF. When browsing a Web page or site, the user's Web browser requests and fetches web page content from a computer linked to the Web. The browser recognizes text information, formatting information, and link information. The browser then paints the screen according to directives contained in this information. Images, text, video and sometimes sound are then presented to the viewer of the web site.

Web sites are built for many different objectives, including advertising products and services, selling products and services and distributing corporate and government information. In order to maximize the effectiveness of these sites, web site owners and developers try to make web sites interactive, interesting, educational, and entertaining. One of the methods to gauge the effectiveness of different aspects of the web sites is to survey visitors of the sites.

The owners of web sites are very interested in maintaining and increasing the consumer base that visits their Web sites. Some sites use a survey mechanism to gauge the satisfaction of visitors to their web site. To participate in the survey, visitors are directed to a separate web page containing a questionnaire. The visitors may choose to provide the requested information or continue browsing the Web. There is no way to tell what percentage of visitors to the web site are responding to the surveys.

In the prior art there have been developed different systems to conduct a survey of users of a web site on a computer network. For instance, U.S. Pat. No. 6,070,145 is directed to a system which utilizes computer program instructions embedded into a web page located at the web site. The computer program instructions invoke a survey program when a visitor accesses the web site. In particular, the program activates a survey request to selected users according to offering criteria based upon either a random or systematic participant selection. The method purportedly sends the user to a different web site if the user chooses to complete the survey. This, of course slows the process and the user's eventual access to the web site information document. The method further purports to withhold sending the information document and the actual survey until the participant has been afforded an opportunity to access the survey (i.e., asked whether he or she wants to participate). In other words, the survey itself is only presented to the participant who accepts the opportunity, and the information document itself is sent to a selected user only after he or she declines the survey or completes it. Lastly, the offering criteria used to determine which users may become survey participants does not seem to take into consideration how many surveys are needed to formulate a statistically relevant sample.

In all such survey systems, a primary concern is the generation of statistically relevant data. Prior art surveys are not statistically representative of the visitors to the site. Therefore, this method of surveying is not practical for serious information gathering. Achieving a statistically significant sample is a problem in surveying a Web population. A secondary concern is retention of visitors to web sites. Directing visitors to a separate web page to complete a survey delays viewing of the web site and may cause the visitor to go to other sites.

### SUMMARY OF THE INVENTION

The object of the present invention is to provide a survey system where the data is centrally maintained and the data collected is statistically relevant.

Thus, a system according to an exemplary embodiment of the present invention is provided to achieve this object. The system includes a survey server, a web site server, a network, and a plurality of visitors. The survey server, the web site server and the plurality of visitors are connected to each other through the network. A web site is stored on the web site server. One of the plurality of visitors connects to the web site server through the network and views the web site. The survey server receives a request from the web site server to conduct a survey of a selected visitor. The survey server transmits a pop-up window to the visitor and transmits the survey to the pop-up window.

Preferably, the pop-up window does not interfere with the web page.

Preferably, the pop-up window is fully branded and can be closed at any time ending the survey. If the pop-up window is closed prematurely the data collected by the survey is invalidated. The survey server controls the entire surveying process and data collection process.

Preferably, the survey presents the visitor with a set of profiling questions. The set of profiling questions preferably number more than four and less than eight.

Preferably, the survey presents the visitor with a set of critical attributes and the visitor ranks the importance of each critical attribute. Each critical attribute is ranked on a scale from 1 to 9. The visitor is presented with a subset of the total number of critical attributes being tested by the web site.

Preferably, the survey presents the visitor with the set of critical attributes to rank the visitor's satisfaction with each of the critical attributes. The visitor ranks the visitor's satisfaction on a scale of 1 to 9.

Preferably, the survey presents the visitor with an appeasement screen which contains a brief automatic response customized based on the rankings of the critical attributes. The appeasement screen is preferably presented to the visitor only when the critical attribute rankings show the visitor is displeased.

Preferably, the first server transmits the pop-up window to the visitor on every n^{th} request. The first server recalculates n on a daily basis. N is calculated in order to maintain a statistically relevant sample. N is calculated based on the number of surveys already collected and the daily traffic to the web site.

Preferably, the survey request is generated by a trip-wire in the web site.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 is a simplified block diagram illustrating an overview of the present system.

FIG. 2 is a simplified flow chart illustrating how a client server responds according to the present system.

FIG. 3 is a simplified flow chart illustrating how a central server responds according to the present system.

FIG. 4 is a simplified flow chart illustrating how a survey is launched from the central server according to the present system.

FIG. 5 is a simplified flow chart illustrating how a survey is administered from the central server according to the present system.

FIG. 6 is a simplified flow chart illustrating how a reward is administered from the central server according to the present system.

FIG. 7 is a schematic diagram of a survey database record according to the present system.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF PREFERRED EMBODIMENTS

The invention is herein described with respect to online surveying of traffic to a web site, but it will be recognized that the system and the configuration of the system can be likewise arranged for traditional surveys.

FIG. 1 is a simplified depiction of a system 100 according to the current invention. A central server 102 is provided, which houses a CPU 104, a data storage unit 106, and a database 108. The central server 102 is connected to a communications network 110, preferably the Internet though the communications network can be the Internet, an intranet, a local area network, and/or a wide area network. A first client server 112 is provided, which houses a CPU 114, a data storage unit 116, and a database 118. The first client server 112 is connected to the communications network 110. A second client server 122 is provided, which houses a CPU 124, a data storage unit 126, and a database 128. The second client server 122 is connected to the communications network 110. A plurality of visitors 130 are also connected to the communications network 110. It should be understood that the central server 102, the first client server 112, the second client server 122, and the plurality of visitors 130 can communicate data messages to each other over the communications network 110.

A web site is stored in the data storage unit 116 of the first client server 112, and runs on the CPU 114 of the first client server 112. The web site may be adapted to provide any type of information to the visitor. The web site computer code, which is used to instruct the first client server 112 which information to provide a visitor and how to present that information, has at least one execution call to the central server 102 disposed within itself.

A web site is stored in the data storage unit 126 of the second client server 122, and runs on the CPU 124 of the second client server 122. The web site may be adapted to provide any type of information to the visitor. The web site computer code, which is used to instruct the second client server 122 which information to provide a visitor and how to present that information, has at least one execution call to the central server 102 disposed within itself.

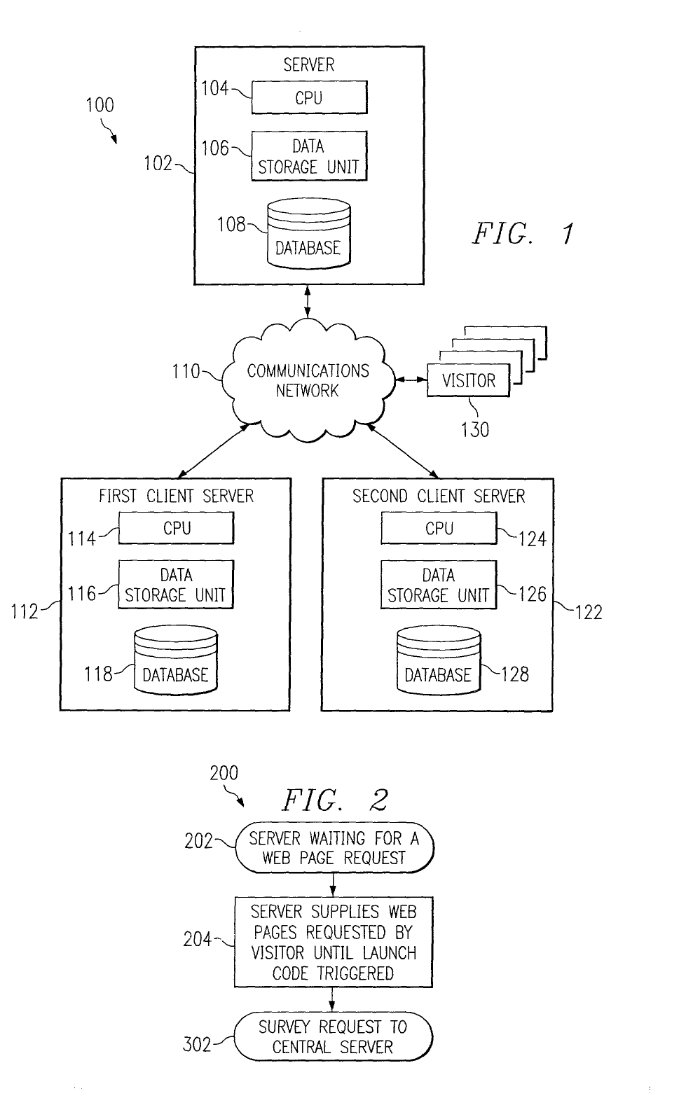

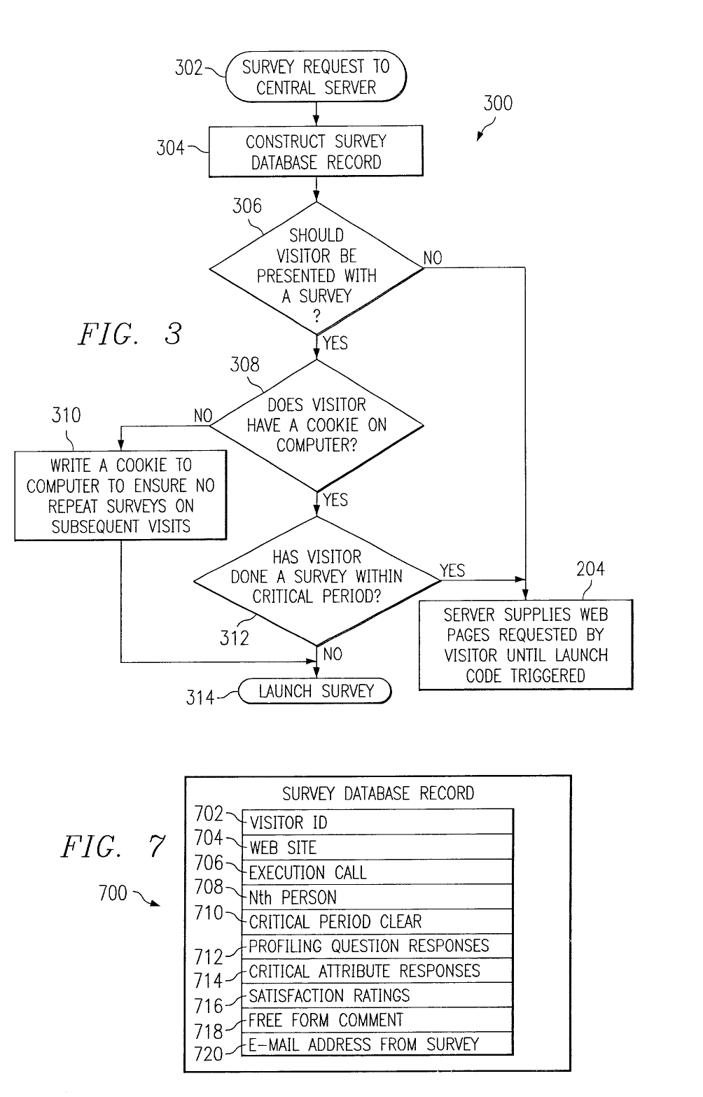

FIG. 2 is a simplified flow chart 200 showing how the first client server 112 responds to a visitor of the plurality of visitors 130. It should be understood that the second server 122 responds in the same manner. A process block 202 shows the first client server 112 waiting for a visitor to request a web page. Once a visitor requests a web page stored on the first client server 112, the first client server 112 executes process block 204. The first client server 112 provides the visitor with content described by the requested web page. The visitor is free to explore the web site provided by the first client server 112 or leave the web site and continue to browse other sites on the Internet. While the visitor is browsing the web site, the visitor may trigger one of the at least one execution calls to the central server 102 disposed within the web site computer code. The execution calls can be placed anywhere throughout the web site. The execution call is called a trip-wire. For example, the trip-wire can be a line of text in the web site which causes the web site to formulate a request for a survey which is sent to the central server 102. This freedom of placement allows the survey launched by the central server 102 the freedom to monitor different functional areas of the web site. Further, the execution calls remain in place at all times, so the survey software is constantly running. Each execution call passes an argument to the central server 102 which identifies the web site and the particular execution call within the web site. If the one of the at least one execution calls to the central server 102 is not triggered, the visitor leaves process block 204 only when the visitor chooses to leaves the web pages provided by the first client server 112. If the one of the at least one execution calls to the central server 102 is triggered the first client server 112 executes a process block 302 which sends a survey request to the central server 102. The first client server 112 continues to download the requested web pages to the visitor's computer.

FIG. 3 is a simplified flow chart 300 showing how the central server 102 responds to a request for a survey. The central server 102 waits in process block 302 until it receives a survey request from another server. Once the central server 102 receives the survey request it executes process block 304.

Executing process block 304 causes the central server 102 to make a survey database record 700 in the database 108 of the central server 102. The fields of the survey database record 700 are initialized, and a web site field 704 and a execution call field 706 of the survey database record identifier 700 are populated with the name of the web site and the execution call where the survey request initiated from respectively. After the survey database record 700 is updated the central server 102 executes decision block 306.

FIG. 7 shows the survey database record 700 according to the present invention. The survey database record 700 shown in FIG. 7 contains 10 fields. The first field of the survey database record 700 is a visitor identification field 702. The visitor identification field 702 is meant to store the visitor identification number which can be found in a cookie on the visitor's computer. The cookie is created by the central server 102. The second field is a web site field 704. This field contains the name of the web site that sent the survey request. The third field is an execution call field 706. The execution field 706 contains an identifier which tells the central server 102 which execution call launched the survey. Knowing which execution call initiated the survey allows the central server 102 to break down data gathered from a web site by the central server 102 into data gathered from particular portions of the web site. The fourth field is a n^{th} person field 710. This field tells whether the visitor was the n^{th} visitor to trip the launch code and thus receive the survey. The fifth field is a critical period field 712. This field tells whether the visitor was present with a survey in the recent past, and thus was not present with a survey at this point. The sixth field is a profiling question responses field 714. This field contains the visitor's responses to the profiling questions. The seventh field is the critical attribute responses field 716. This field contains the visitor's responses to the critical attribute questions. The eighth field is the satisfaction ratings field 718. This field contains the visitor's responses to the satisfaction ratings questions. The ninth field is the free form comment field 720. This field contains the visitor's free form comment. The tenth field is the email address field 722. This field is meant to contain the visitor's email address. All fields are initialized to be blank.

The central server 102 performs a calculation while executing decision block 306 to see if the visitor should be present with a survey. Every visitor is not present with a visitor survey. The survey launched by the central server 102 employs a sampling strategy where only every n^{th} visitor is present with a survey, where n is any whole positive integer. Preferably, a calculation is performed on a daily basis which statistically calculates n in order to get the needed sample to ensure statistically relevant data. This calculation is based on site traffic and the number of surveys collected. It should be understood that alternate sampling strategies can be used. If the current visitor is not the n^{th} visitor, the central server 102 executes process block 316. If the visitor is the n^{th} visitor, the central server 102 stores a true value in the n^{th} person field 708, and the central server 102 executes decision block 308.

While executing the decision block 308 the central server 102 searches the visitor's computer for the cookie. The cookie is a computer file written by the central server 102, which specifically identifies the visitor's computer to the central server 102. If there is no cookie on the visitor's computer which has been written by the central server 102, the central server 102 executes process block 310 which writes a new cookie to the visitor's computer, The central server 102 records the present time and date in the cookie, writes the identification number and executes process block 314 which is stored in the cookie to the visitor identification field 702, launches a visitor survey. If there is a cookie on the visitor's computer, the central server 102 records the identification number stored in the cookie in the identification number field 702, and executes decision block 312.

While executing decision block 312, the central server 102 scans the cookie on the visitor's computer to ascertain how long it has been since the visitor last completed a survey. If the visitor has not completed a survey within the critical period, which can be set at any period of time but is preferably 180 days, the central server 102 executes process block 314 and marks the critical period field 710 as true. If the visitor has completed a survey within the critical period the central server 102 executes the process block 316. Process block 316 records all the information collected during the survey's execution in the database record created on the central server 102.

The central server 102 executes process block 314 which launches a visitor survey. Launching the visitor survey does not prevent the visitor from receiving the page the visitor originally requested. The visitor survey collects data from individual visitors about the web site they were are visiting. FIG. 4 is a flow chart 400 showing the process by which a server administers a visitor survey according to the present invention. Once the central server 102 launches the visitor survey the central server 102 executes decision block 402 which asks the visitor if the visitor would be willing to complete the visitor survey. The visitor survey is conducted entirely within a pop-up window. The entire survey is downloaded to the visitor's computer at the same time whether the visitor elects to take the survey or not. The pop-up window is fully branded with the web site owner's look and feel to the window. The pop-up window does not prevent the visitor from receiving or viewing the page the visitor originally requested. The pop-up window is smaller than the size of the screen, preferably 20% of the size of the screen, and the pop-up window can be closed by the visitor at any time. The visitor is informed that the visitor survey will take a small amount of time, preferably 60 seconds, and that by completing the visitor survey the visitor can earn credit in a reward program if the web site owner sponsors a reward program. If the visitor elects against completing the visitor survey the central server 102 executes process block 316. If the visitor elects to complete the visitor survey the central server 102 executes process block 404.

In an alternate embodiment, decision block 402 is optimized out of the process. After the central server 102 exits process block 314, the central server 102 executes process block 404, bypassing decision block 402. This execution path is illustrated by dotted arrow 403.

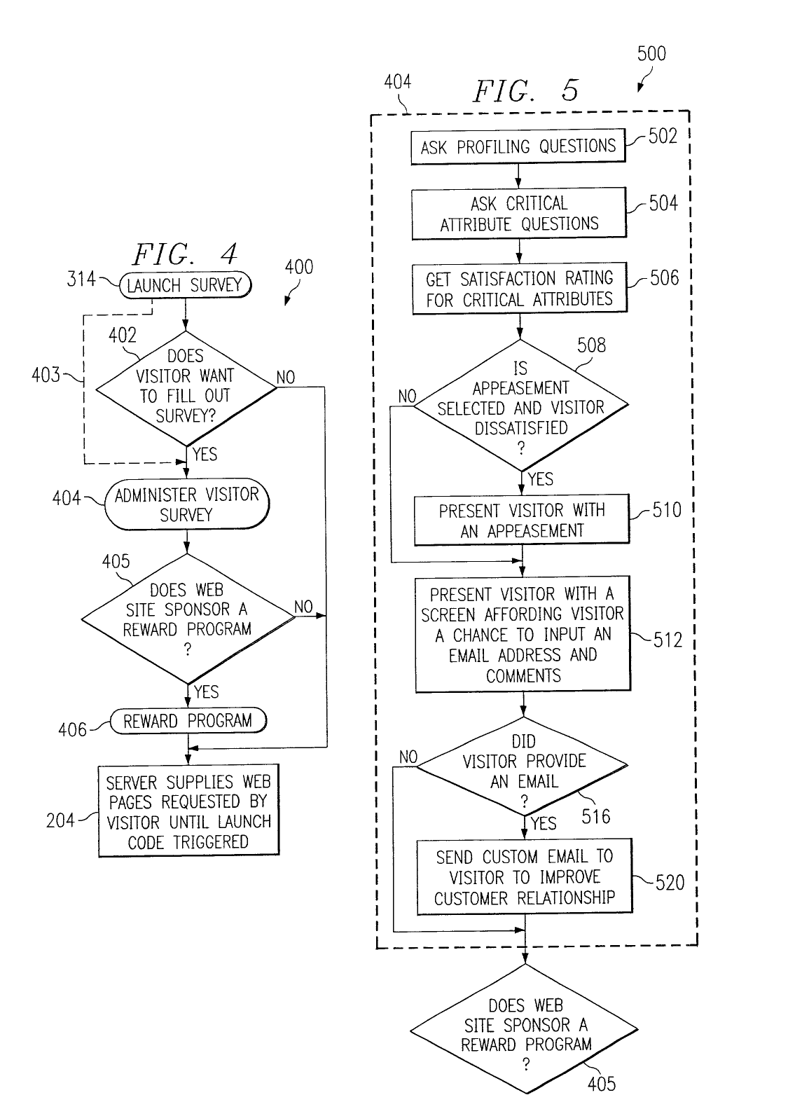

The process block 404 is executed by the central server 102 and a survey is administered to the visitor. The process block 404 is described in further detail in FIG. 5. After the visitor is finished completing the survey the central server 102 executes the decision block 405.

Executing decision block 405 causes the central server 102 to consult the database 108 and ascertain whether the web site that launched the survey sponsors a reward program. If the web site sponsors a reward program process, block 406 is executed. If the web site does not sponsor a reward program, process block 304 is executed.

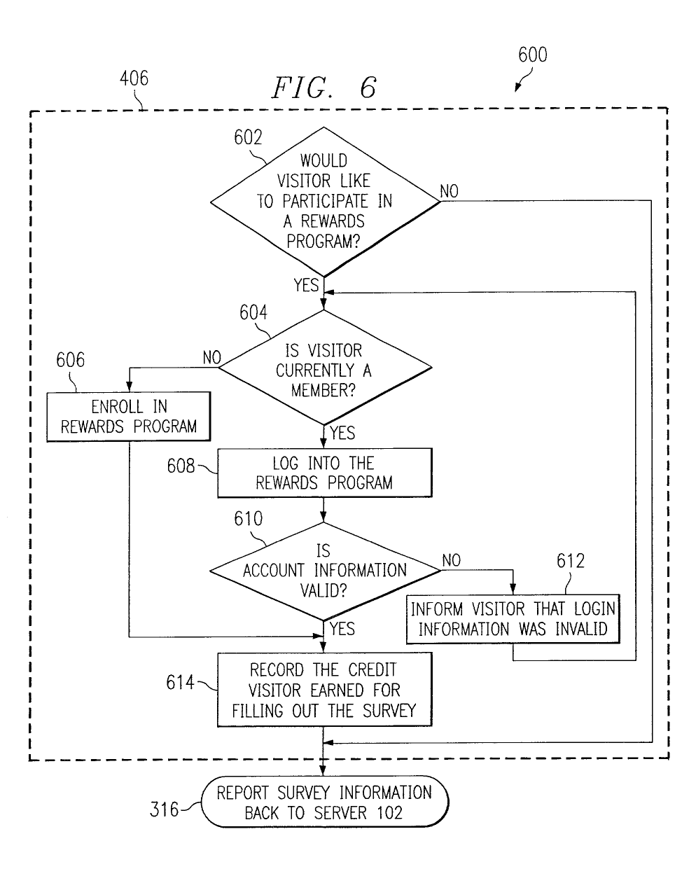

Executing the process block 406 causes the central server 102 to present the visitor with the reward program. The process block 406 is described in further detail in FIG. 6. After the visitor inputs the information necessary for the central server 102 to credit the visitor with a reward, the central server 102 exits the process block 406.

After the central server 102 exits the process block 406, the process block 204 is executed. The pop-up window closes and the visitor is free to browse the web pages offered by the first client server 112 or any other web pages offered over the communications network 110.

FIG. 5 is a flow chart depicting the processes which take place within process block 404. The first process executed by the central server 102 within process block 404 is process block 502. The central server 102 presents the visitor with profiling questions while executing process block 502. The profiling questions seek to measure characteristics of the visitor's Internet usage including: stated frequency of visitation, share of market, overall site interest, likelihood to return, average purchase amount, frequency of support use, and intensity of support issues. There can be as few as four and as many as eight profiling questions. If the decision block 402 was not executed, and the bypass path 403 was used, the process block 502 also presents the visitor with a question asking if the visitor wants to opt out of answering the survey. The visitor answers the profiling questions or opts out of answering the profiling questions, and clicks on the next button. The central server 102 records the collected data in the profiling questions field of the survey database record 700 and executes process block 504.

While executing process block 504, the central server 102 requests that the visitor score the importance of certain critical attributes to the visitor. Critical attributes as formulated by the survey allow the survey to adhere to the strict methodological practices needed to efficiently measure customer satisfaction in the online world. The visitor is presented with a random subset of the total number of critical attributes to score, preferably the visitor is presented with four critical attributes. The web site can monitor any number of critical attributes, preferably twenty. The visitor may be presented with four critical attributes to score during a survey though the web site owner is attempting to measure 20 or more critical attributes. This is done to keep the survey time low. The visitor scores the importance of the critical attributes on a scale from 1 to 9. Should the site visitor not have enough knowledge to comment on an attribute, the visitor may “SKIP” that particular attribute. The critical attributes are broken down into the categories including: Internet norms, industry norms, and customized attributes. Internet norms include overall appearance of an Internet site, ease of navigation through the site, web site speed, customer service, and freshness of content. Industry norms are based on the client's business industry and allow the central server 102 to provide comparative benchmarks to web sites. The customized attributes are customized to the client's unique business needs. After the questions are answered the visitor clicks on the Next button, the central server 102 records the collected data in the critical attribute responses field 714 of the survey database record 700 and executes the process block 506.

The process block 506 presents the visitor with a screen which asks the visitor to rank his or her satisfaction with the certain critical attributes scored above. The visitor ranks his or her satisfaction with the critical attributes on a scale from 1 to 9. Should the site visitor not have enough knowledge to comment on an attribute, the visitor may “SKIP” that particular attribute. After the critical attributes are scored according to the visitor's satisfaction, the visitor clicks on the Next button. Clicking on the Next button causes the central server 102 to store the collected data in the satisfaction ratings field 716 of the survey database record 700 and to execute the decision block 508.

In an alternate embodiment, the critical attributes may be ranked according to the visitor's input. When organizing the window, the central server 102 may organize the critical attributes in the window according to how important each critical attribute is to the visitor. Organizing the critical attributes in the window according to how they were valued by the visitor is called active listening. This listening technology dramatically improves completion rates and makes the respondent feel like their input is valuable.

The central server 102 analyzes the satisfaction rating scores the visitor awarded to the critical attributes and checks to see if the appeasement screen option is selected while executing decision block 508. If the scores for the critical attributes show that the visitor was dissatisfied and the appeasement screen option is selected, the central server 102 executes process block 510. The criteria that the distributed software system uses to decide whether the visitor was dissatisfied is fully customizable. If either the scores for the critical attributes show that the visitor was satisfied, or the appeasement screen option is not selected, the central server 102 executes process block 512.

Executing the process block 510 causes the visitor to be presented with an appeasement screen. The appeasement screen contains a short and informative statement apologizing for the critical attributes that dissatisfied the visitor. Each critical attribute the visitor is dissatisfied with has its own appeasement message. This appeasement further enhances the interactive experience and builds customer loyalty. The visitor clicks on a Next button when done reading the appeasement screen, and the central server 102 executes process block 512.

The process block 512 presents the visitor with a screen which offers the visitor the option to enter free form comments and an email address. The visitor is free to leave open-ended feedback which is designed to allow respondents to comment on any concerns not addressed by the surveyed critical attributes. The open-ended feedback can be written about any part of the web site from commenting on the web site's look and feel to commenting on additional services the visitor would find useful. This unstructured feedback is tabbed and sorted by topic and may lead to the creation of new critical attributes. The visitor is also afforded the option to enter his or her email address. Neither the open-ended feedback or the email address are required. After the visitor has finished commenting or inputting the visitor's email address, the visitor clicks on the Next button which causes the central server 102 to store the free form comment in the free form comment field 718 of the survey database record 700, store the email address in the email address field 720 of the survey database record 700, and to execute the decision block 516.

The central server 102 analyzes database record 700 to ascertain whether an email address was provided while executing decision block 516. If no email address was provided the central server exits process block 404 and begins execution of decision block 405. If an email address was provided, the central server executes process block 520. Executing process block 520 causes the central server to schedule a custom email to be sent to the visitor at a later time to keep the visitor informed. The central server 102 exits process block 520 and in turn exits process block 404. The central server 102 then begins execution of decision block 405.

FIG. 6 is a simplified flow chart 600 showing the process block 406 in more detail. Process block 406 begins by executing decision block 602. Executing decision block 602 causes the central server 102 to ask the visitor whether the visitor would like to participate in a rewards program. Participation in the rewards program is voluntary. The rewards program gives visitors an incentive to complete the current survey and incentive to complete future surveys. The rewards programs can be offered by the web site that requested the survey or by a third party that offers a more general online rewards programs. In either case the web site that requests the survey must authorize and finance this program. If the visitor indicates he or she does not want to participate in the rewards program, the central server 102 exits process 406 and executes process block 204. If the visitor wants to participate in the rewards program the central server 102 executes the decision block 604.

Executing decision block 604 causes the central server 102 to present a question asking if the visitor is currently a member of the rewards program. If the visitor responds that the visitor is a member of the rewards program, the central server 102 executes the process block 608. If the visitor is not a member of the rewards program, the central server 102 executes the process block 606.

Executing the process block 608 causes the central server 102 to prompt the visitor for login information. The visitor is asked to input the visitor's user name, password, and email address. Once the information is input the visitor clicks on the submit button and the central server 102 executes the decision block 610. The central server 102 checks to see if the information provided by the visitor is correct for a valid account on the applicable reward program. If the information is correct, the central server 102 executes process block 614. If the information is incorrect, the central server 102 executes process block 612. Executing process block 612 causes the central server 102 to inform the visitor that the user information is incorrect and executes decision block 604 again.

If the visitor previously indicated that he or she did not have an account in the rewards program the central server 102 executes process block 606 and prompts the visitor to create a new account. The visitor is required to input a username, password and valid email address. After this information is input into the screen the visitor must click on the Submit button. Clicking on the Submit button causes the central server 102 to check to see if an identical account for the applicable rewards program has already been created. If the identical account has already been created, the central server 102 asks the visitor to provide another username. If no other account has the same username the central server 102 creates a new rewards program account and awards the visitor with the credit. After the new account is created, the central server 102 executes the process block 614.

Executing the process block 614 causes the central server 102 to record the credit earned by the visitor in the applicable reward program. After the credit is recorded the first client server exits process block 406 and executes process block 204.

In a preferred embodiment, the entire survey is prepared by the central server 102 and downloaded as an executable to the visitor's computer to be executed on the visitor's computer.

Those of ordinary skill in the art will appreciate that the foregoing discussion of certain preferred embodiments is illustrative only, and does not limit the spirit and scope of the present invention, which are limited only by the claims set forth below.

What is claimed:

1. A method for conducting a survey of a visitor to a web page, comprising the steps of:
providing a survey server to conduct the survey;
storing the web page on a web server;
sending the web page to a first computer being used by the visitor from said web server;
receiving a request at said survey server from the web page to conduct said survey;
responding to said request by transmitting a pop-up window from said survey server to the visitor at the visitor's computer;
presenting a survey document to the visitor through said pop-up window; and
conducting said survey in said pop-up window.

2. The method of claim 1 wherein said pop-up window does not interfere with the web page.

3. The method of claim 1 wherein the survey document contains an option to opt out of the survey.

4. The method of claim 1 wherein said pop-up window can be closed at any time ending the survey.

5. The method of claim 4 wherein the data collected by said pop-up window that was prematurely closed is disregarded.

6. The method of claim 1 further comprising the step of: presenting the visitor with a set of profiling questions.

7. The method of claim 6 wherein said set of profiling questions number more than four.

8. The method of claim 6 wherein said set of profiling questions number less than eight.

9. The method of claim 1 further comprising the step of: presenting the visitor with a set of critical attributes.

10. The method of claim 9 wherein the visitor ranks the importance of each of said set of critical attributes.

11. The method of claim 10 wherein the visitor ranks the importance of each of said set of critical attributes on a scale of 1 to 9.

12. The method of claim 9 wherein the visitor is presented with a subset of the total number of critical attributes being tested by the web site.

13. The method of claim 12 wherein the number of critical attributes being ranked is about four.

14. The method of claim 12 wherein the number of critical attributes being tested by the web site is about twenty.

15. The method of claim 9 further comprising the step of: ranking the visitor's satisfaction with each of said set of critical attributes.

16. The method of claim 15 wherein the visitor's satisfaction is ranked on a scale of 1 to 9.

17. The method of claim 9 wherein said set of critical attributes allow said survey to adhere to a strict methodological practice.

18. The method of claim 17 wherein said strict methodological practice is designed to efficiently measure customer satisfaction in the online world.

19. The method of claim 18 further comprising the step of: presenting the visitor with an appeasement screen.

20. The method of claim 19 wherein the appeasement screen contains a brief automatic response customized based on the critical attribute rankings.

21. The method of claim 19 further comprising the step of: presenting the appeasement screen only when the visitor is displeased.

22. The method of claim 21 wherein the visitor is designated as displeased if the rank given to any of the critical attributes is lower than a determining level.

23. The method of claim 22 wherein said determining level is determined by the web site.

24. The method of claim 1 wherein the server controls the entire surveying process.

25. The method of claim 1 wherein the server controls the entire data collection process.

26. The method of claim 1 wherein the server is constantly enabled to receive for survey requests from the web site.

27. The method of claim 1 wherein the request is generated by a trip-wire.

28. The method of claim 27 wherein said trip-wire is a line of code in the web site.

29. The method of claim 27 wherein said trip-wire can be placed anywhere within the web site.

30. The method of claim 27 wherein the request identifies said trip-wire that originated the request.

31. The method of claim 1 further comprising the step of: transmitting said pop-up window to the visitor every n^{th} request from the web site.

32. The method of claim 31 wherein n is determined by the server.

33. The method of claim 31 wherein n is calculated on a daily basis.

34. The method of claim 31 wherein n is calculated by in order to attain a statistically relevant sample.

35. The method of claim 31 wherein n is calculated based at least in part on daily traffic to the web site and the number of surveys already collected about the web site.

36. The method of claim 1 wherein said pop-up window is fully branded.

37. The method of claim 36 wherein the full branding gives said pop-up window the look and feel of the web site

38. The method of claim 1 wherein the request identifies the web site that originated the request.

39. The method of claim 1 further comprising the step of: offering the visitor an inducement for completing the survey.

40. The method of claim 39 wherein the inducement is defined by the web site that requested the survey.

41. The method of claim 39 wherein the inducement is offered by the web site that requested the survey.

42. The method of claim 39 wherein the inducement is offered by a third party.

43. The method of claim 42 wherein the inducement is financed by the web site that requested the survey.

44. The method of claim 39 wherein the inducement is fully voluntary.

45. The method of claim 39 wherein the inducement is not awarded until the visitor has completed the entire survey.

46. The method of claim 39 wherein the inducement is a reward.
